(19) United States
(12) Patent Application Publication
(10) Pub. No.: US 2006/0088038 A1
(43) Pub. Date: Apr. 27, 2006

(54) Relationship definition and processing system and method

(75) Inventors: Vasantha K. Ravula, Sammamish, WA (US); Neelima R. Polam, Richmond, VA (US)

Correspondence Address: HALLISKY & PHILIPP, 1725 WESTLAKE AVENUE NORTH, SUITE 150, SEATTLE, WA, 98109, US

(73) Assignee: Inkaar, Corporation, Samamish, WA (US)

(21) Appl. No.: 11/226,052

(22) Filed: Sep. 13, 2005

Related U.S. Application Data
(60) Provisional application No. 60/522,291, filed on Sep. 13, 2004.
(60) Provisional application No. 60/595,365, filed on Jun. 27, 2005.

(51) Int. Cl. H04L 12/56

(52) U.S. Cl. 370/397

(57) ABSTRACT

A computer implement method of defining relationships is provided herein.

### RELATED APPLICATIONS

This application claims the benefit of U.S. Provisional Patent Application No. 60/522,291, entitled A RELATIONSHIP MANAGEMENT SYSTEM REPRESENTING RELATIONS BETWEEN ENTITIES WITH A RELATION TYPE, AIDING AND CAPTURING RELATION CHARACTERISTICS USING COLLABORATION TOOLS, PUBLISHING QUERYING AND ANALYZING HISTORICAL DATA, REQUESTING REFERRAL INFORMATION FROM PEER AND SERVICES, filed on Sep. 1 3, 2004, and U.S. Provisional Patent Application No. 60/595,365, entitled THIS INVENTION IS A SOFTWARE PROCESS TO CREATE RELATIONS NETWORK BY DEFINING A TIE (RELATION TYPE) AND ASSOCIATING IT BETWEEN ENTITIES, INFERRING RELATIONS FROM NETWORK BASED ON TYPE DEFINITION, EXCHANGING RELATION AS METADATA DURING COLLABORATION ACTIVITY, MEASURING RELATION STRENGTH, TRUST FACTOR, PRIVACY CONTROLLING THE INFORMATION BEING SHARED, PUBLISHING AND SERVING ALERTS TO RELATION NETWORK ENTITIES, PERSISTING AND USING ENTITY TESTIMONIALS TO CALCULATE THE TRUST FACTOR, filed on Jun. 27, 2005, which are hereby incorporated by reference.

### FIELD

The present invention generally relates to relations and, more particularly, to relations in communications systems.

### BACKGROUND

Communication networks are well known in the computer communications field. By definition, a network is a group of computers and associated devices that are connected by communications facilities or links. Network communications can be of a permanent nature, such as via cables, or can be of a temporary nature, such as connections made through telephone or wireless links. Networks may vary in size, from a local area network (“LAN”), consisting of a few computers or workstations and related devices, to a wide area network (“WAN”), which interconnects computers and LANs that are geographically dispersed, to a remote access service, which interconnects remote computers via temporary communication links. An internetwork, in turn, is the joining of multiple computer networks, both similar and dissimilar, by means of gateways or routers that facilitate data transfer and conversion from various networks. A well-known abbreviation for the term internetwork is “internet.” As currently understood, the capitalized term “Internet” refers to the collection of networks and routers that use the Internet Protocol (“IP”), along with higher-level protocols, such as the Transmission Control Protocol (“TCP”) or the Uniform Datagram Packet (“UDP”) protocol, to communicate with one another.

Many communication systems that utilize communication networks have listings of contacts that may be reached using the communications system. Likewise, Personal Information Managers (“PIMs”) may have listings of contacts that may allow a user to communicate with the contact via a communications network.

Such systems have proved commercially successful and desirable for a number of reasons. In particular, PIMs allow users to arrange their contacts in lists and to synchronize the contacts with multiple devices. However, the categorization of contacts using conventional PIMs and communication systems is generally arbitrary and does not capture relationships between contacts.

One drawback of current social networks or other organizational networks is that entities are merely linked, and link is called a relationship. This mechanism allows entity connection, traversing through the connections and sometimes determining a connection path. However, current network fail to define the links to other entities in a structured manner.

Previous systems have been proposed to extract relations by scavenging PIMs', information, organizing the entities in address books and connecting address book entities. Likewise, there are directory systems and address book systems for grouping with associated categories. These mechanisms use unbounded and unstructured categories and fail to provide a structured environment for defined relations.

Additionally, current relationship systems fall short of the privacy needed by entities in the social networks. Social networks benefit from a mechanism to control who can reveal what information about the other person or group.

### BRIEF DESCRIPTION OF THE DRAWINGS

FIG. 1 is a pictorial diagram of a number of interconnected devices that provide a connected user device relationship defining functionality in accordance with various embodiments.

FIG. 2 is a block diagram of a user device that provides an exemplary operating environment for one embodiment.

FIG. 3 is a block diagram of a relationship server that provides an exemplary operating environment for one embodiment.

FIG. 4 is a diagram illustrating the actions taken by devices in a relationship system for processing a relationship defining transaction in accordance with one embodiment.

FIG. 5 is a flow diagram illustrating a relationship defining routine in accordance with one embodiment.

FIG. 6 is a flow diagram illustrating a relationship processing routine in accordance with one embodiment.

FIG. 7 is a diagram illustrating the actions taken by devices in a relationship system for processing a relationship definition in accordance with one embodiment.

FIG. 8 is a flow diagram illustrating a relationship and link processing routine in accordance with one embodiment.

FIGS. 9-11 illustrate exemplary user interfaces suitable for use in various embodiments.

### DETAILED DESCRIPTION

The detailed description that follows is represented largely in terms of processes and symbolic representations of operations by conventional computer components, including a processor, memory storage devices for the processor, connected display devices and input devices. Furthermore, these processes and operations may utilize conventional computer components in a heterogeneous distributed computing environment, including remote file Servers, computer Servers and memory storage devices. Each of these conventional distributed computing components is accessible by the processor via a communication network.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

Social networking is one way to organize people in a network depending on their social, familial and/or business affiliations. Often this may be accomplished by analyzing the communication patterns of people. However, people also organize themselves in defined relationships. By capturing the natural organization of defined relationships in to computerized model, it is possible to utilize these defined relations to give users a user-friendly way of organizing their contacts and information.

In various exemplary embodiments, defined relationships can be grouped into groups of relation types that enable a user to define relations in one or more ways to form a contact network. A contact network is network of family members, workplace members or any group of contacts defined in a group of relation types. By changing the type of group of relation types, it is possible to generate a different type of relationship network. Additionally, in some embodiments, a contact may have more than one specified relationship. For example a contact could have the “Family” relationship “Father” and the “Work” relationship “Reports to.”

Relationship (or relation) type indicates the type of relation that is set between two entities. When setting a relation, the user may select one or more types from predefined types categorized according to groups (e.g., family, work, social, computers, etc.). Some predefined types may be provided with an exemplary application; while other types may be predefined by a user. A type is may have various characteristics, such as the group it is in, its privacy settings, etc.

Groups provide a way to organize relations. Groups make it simpler for a user to find the relations they are looking for based on a search within a specified group. Some system-defined groups may be provided to a user with exemplary implementations. However, a user may also create his/her custom defined group(s). Likewise, a user can create a defined group that specifies one or more groups as having the types of relations that the user wishes to contain in the combined defined group. For example, a user wishing to have family and workplace relations both stored in their “MyWorkingFamily” group, might specify a “family” group type and a “workplace” group type as defining the kind of group that MyWorkingFamily should be.

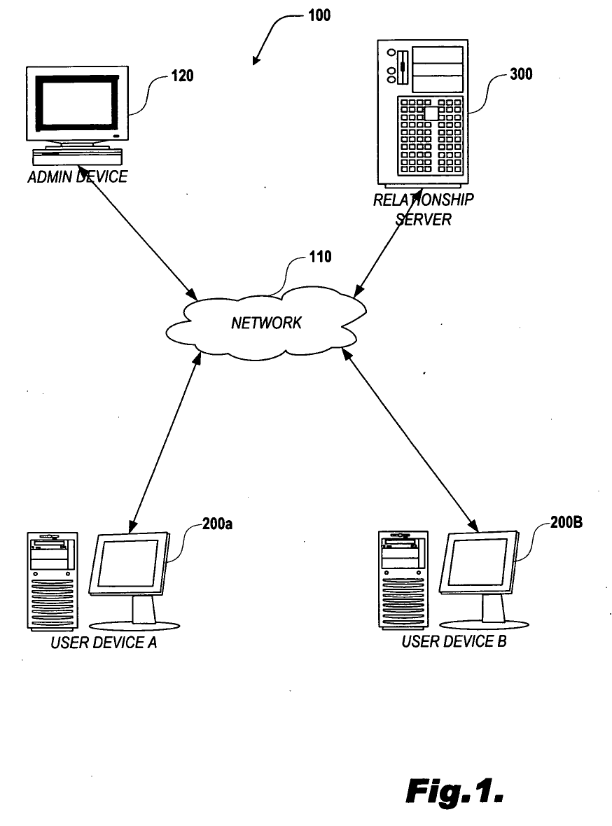

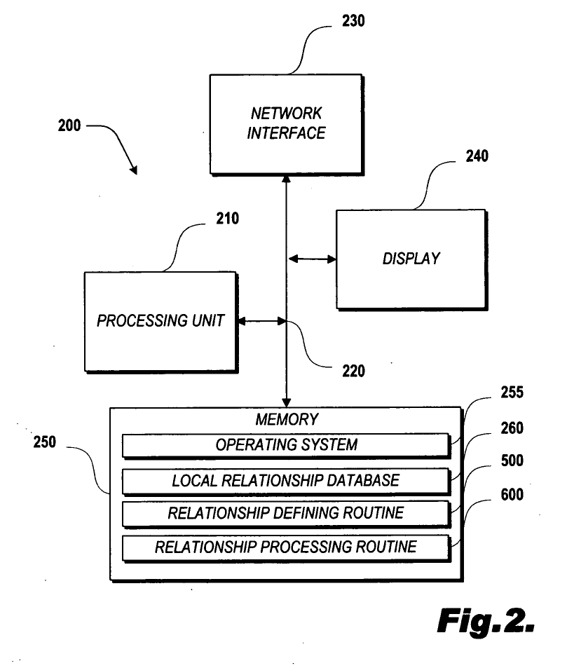

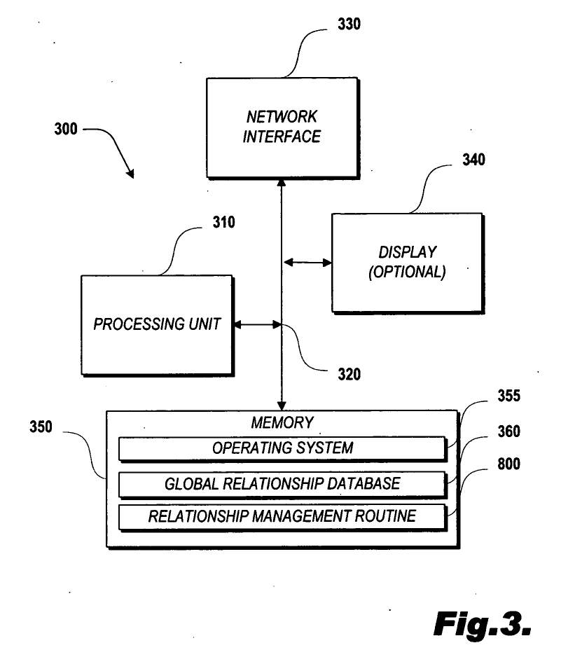

To show the operations of such relationship networks, FIG. 1 illustrates an exemplary integrated relationship system 100 having a number of devices used in exemplary embodiments. FIG. 1 illustrates a first user device 200A (illustrated in FIG. 2 and described below), a network 110, such as a wire or wireless communications network. Also in communication with the network 110 is a second user device 200B, a relationship server 300 (illustrated in FIG. 3 and described below) and optional administration device 120. In alternate embodiments, there may be more user devices 200, relationship servers 300 or administration devices 120. In further embodiments, the roles of ore or more of a user device 200, a relationship server 300 and/or an administration device 120 may be performed by an integrated device (not show) or may be distributed across multiple other devices (not shown). In still further embodiments, still additional devices (not shown) may be utilized in the relationship system 100.

FIG. 2 illustrates several components of an exemplary user device 200. In some embodiments, the user device 200 may include many more components than those shown in FIG. 2. However, it is not necessary that all of these generally conventional components be shown in order to disclose an illustrative embodiment. As shown in FIG. 2, the user device 200 includes a network interface 230 for connecting to the network 110. Those of ordinary skill in the art will appreciate that the network interface 230 includes the necessary circuitry for such a connection and is constructed for use with the appropriate protocol.

The user device 200 also includes a processing unit 210, a memory 250 and may include an optional display 240, all interconnected along with the network interface 230 via a bus 220. The memory 250 generally comprises a random access memory (“RAM”), a read only memory (“ROM”), and a permanent mass storage device, such as a disk drive. The memory 250 stores program code for a relationship defining routine 500 and a relationship processing routine 600, in addition to a local relationship database 260. In addition, the memory 250 also stores an operating system 255. It will be appreciated that these software components may be loaded from a computer readable medium into memory 250 of the user device 200 using a drive mechanism (not shown) associated with a computer readable medium, such as a floppy disc, tape, DVD/CD-ROM drive, memory card, via the network interface 230 or the like.

Although an exemplary user device 200 has been described that generally conforms to conventional general purpose computing devices, those of ordinary skill in the art will appreciate that a user device 200 may be any of a great number of devices capable of communicating with the network 110 or with the relationship server 300.

FIG. 3 illustrates several components of the relationship server 300. In some embodiments, the relationship server 300 may include many more components than those shown in FIG. 3. However, it is not necessary that all of these generally conventional components be shown in order to disclose an illustrative embodiment. As shown in FIG. 3, the relationship server 300 includes a network interface 330 for connecting to the network 110. Those of ordinary skill in the art will appreciate that the network interface 330 includes the necessary circuitry for such a connection and is constructed for use with the appropriate protocol.

The relationship server 300 also includes a processing unit 310, a memory 350 and may include an optional display 340, all interconnected along with the network interface 330 via a bus 330. The memory 350 generally comprises a RAM, a ROM, and a permanent mass storage device, such as a disk drive. The memory 350 stores program code for a relationship and link processing routine 800, in addition to a global relationship database 360. In addition, the memory 350 also stores an operating system 355. It will be appreciated that these software components may be loaded from a computer readable medium into memory 350 of the relationship server 300 using a drive mechanism (not shown) associated with a computer readable medium, such as a floppy disc, tape, DVD/CD-ROM drive, memory card, via the network interface 330 or the like.

Although an exemplary relationship server 300 has been described that generally conforms to conventional general purpose computing devices, those of ordinary skill in the art will appreciate that a relationship server 300 may be any of a great number of devices capable of communicating with the network 110 or with a user device 200.

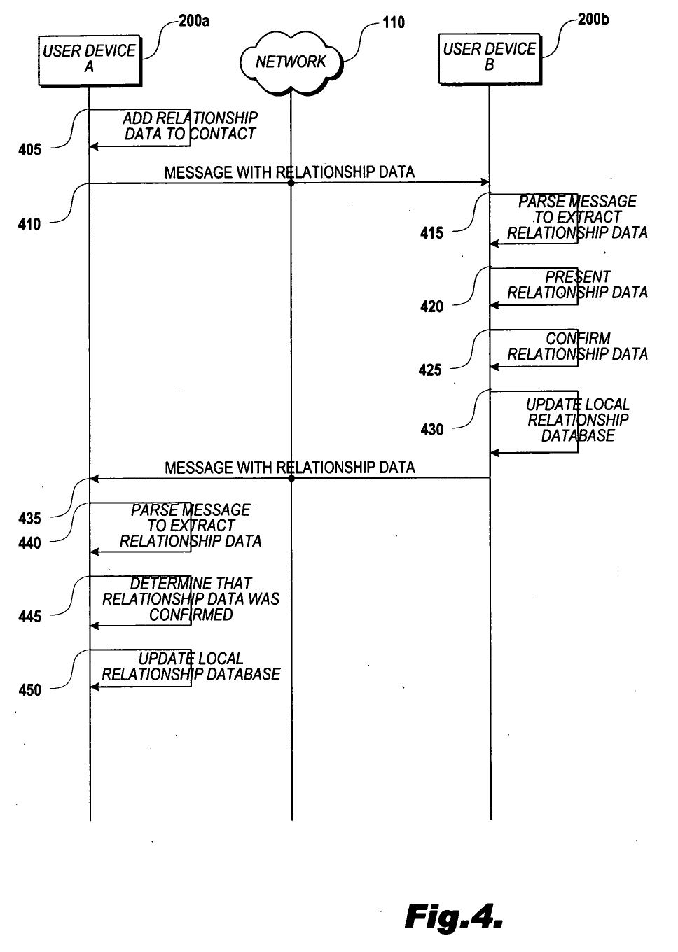

FIGS. 4-8 illustrate exemplary steps to process relationships in an exemplary relationship system 100. Some transactions in the relationship system 100 may be more or differently networked than others. Accordingly, in some embodiments, the number and types of devices may vary.

FIG. 4, for example, illustrates an exemplary peer-to-peer relationship defining transaction where the steps of the transaction take place between at least two peer-level user devices 200A-B. The transaction begins with the first user device 200A adding 405 a relationship data (e.g., by specifying a predefine relationship selected from a group of relationship types) to a contact. The first user device 200A sends 410 a message with the relationship data to the contact at the second user device 200 B via a network 110. At second user device 200B, the message is parsed 410 to extract the relationship data. Next, the relationship data is presented 420 on the second user device 200B. A user viewing the data may confirm 425 that the relationship data is correct and second user device 200B updates 430 a local relationship database (e.g., local relationship database 260) with a confirmation of the relationship. After which, the user of second user device 200B may send 435 a reply message, with relationship data, back to first user device 200A via the network 110.

First user device 200A determines 445 that the relationship data was confirmed (e.g., via header information contacts information attached data, and alike) and updates 450 a local relationship database (e.g., relationship database 260 of first user device 200A) with the confirmation of the relationship.

The offer and acceptance of the relationship allows each user of the system to define their own relationships, while still allowing their relations to likewise define and control their relationships, thereby preserving a desirable level of personal control over personal information. In other words, a person can propose a marriage, but only when the proposal is accepted can there be a true “fiance” relationship.

While an exemplary transaction and types of device has been identified, it will be apparent that in alternate embodiments other types of device may process still other forms transactions. For example, authentication of a user from information provided at the first or second user device 200A, 200B.

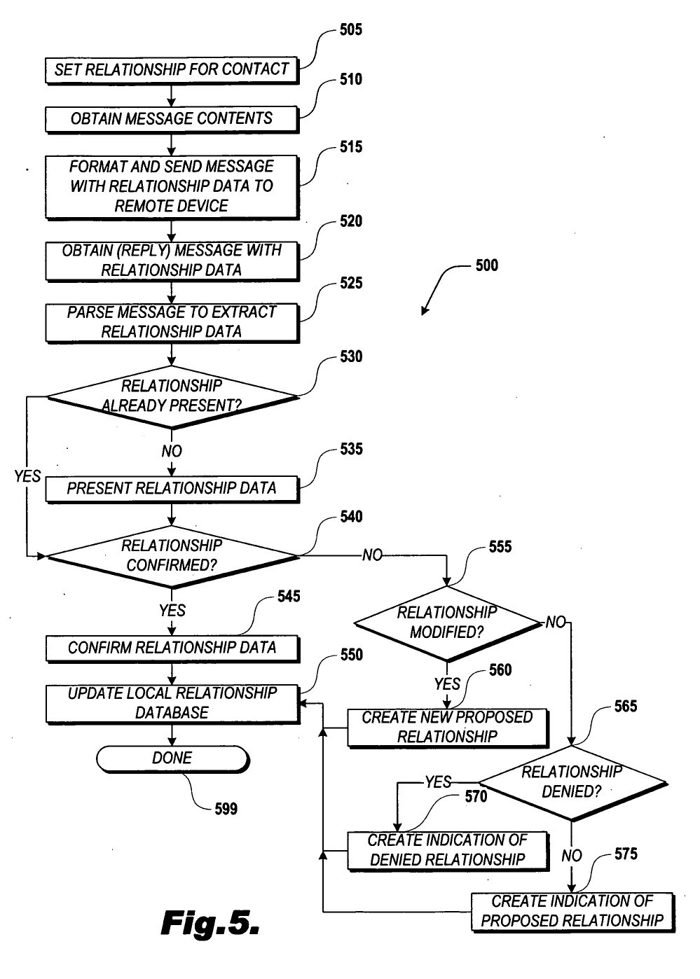

FIG. 5 illustrates an exemplary relationship defining routine 500 suitable for execution on a user device 200. Relationship defining routine 500 begins at block 505 where a relationship is set for a contact. In block 510, the contents of a message are obtained (e.g., a user composes a message, selects a predetermined message or otherwise obtains message contents). In block 515, a message is formatted with the message contents and is sent with the relationship data to a remote device (such as another user device 200 or a relationship server 300 ). Relationship data may accompany the message in any of a variety of manners, including but not limited to, attachments, header information, structured message contents, integrated data and the like.

In some embodiments, the defining of relationship is an asynchronous process. Therefore, in some embodiments, there may be a delay until a reply message is obtained in block 520. Once receive, the reply message is parsed to extract its relationship data in block 525. It will be appreciated that a message obtained from a remote device may be responsive to an originally sent message or may designate its own relationship data.

Accordingly, in decision block 530, a determination is made whether the relationship is already present on a current device. If the relationship is not currently present, processing proceeds to block 535 where the relationship data is presented for a user to determine its status. After which, processing proceeds to decision block 540.

If, however, in decision block 530 it was determined that relationship data was already present, processing proceeds directly to decision block 540 where determination is made whether the relationship data has been confirmed (e.g., after presentation to user or in the reply message obtained in block 520 ). If in decision block 540 it is determined that the relationship is confirmed, processing proceeds to block 545 where the local record of the relationship is confirmed and the local relationship database (e.g., database 260) is updated in block 550. Relationship defining routine 500 ends at block 599.

However, if in decision block 540 it was determined that the relationship was not confirmed, processing proceeds the decision block 555 where determination is made whether the relationship was modified. One example of a modified relationship might be where a person was designated a fiance in a family relationship but was modified to be a spouse (i.e., got married). Other modified relationship may be apparent depending on the relationship types in question.

If in decision block 555 it was determined that the relationship was modified, in block 560 a new proposed relationship is created and processing proceeds to block 550 as described above. The new proposed relationship could be sent in another message (such as is block 515).

However, if in decision block 555 it was determined the relationship was not modified; processing proceeds to block 565 where determination is made whether the relationship was denied. A simple example of a denied relationship might be when one spouse divorces another spouse, the spousal relationship would therefore be broken and accordingly, the relationship could be denied (another way of implementing this may categorize this as a “modified” relationship). If the relationship was denied, as determined in decision block 565, processing proceeds to block 570. In block 570, an indication of the denied relationship is created and processing proceeds to block 550.

If, however, in decision block 565, it was determined that the relationship was not denied, processing proceeds to block 575 where an indication of a proposed relationship is created and processing proceeds to block 550.

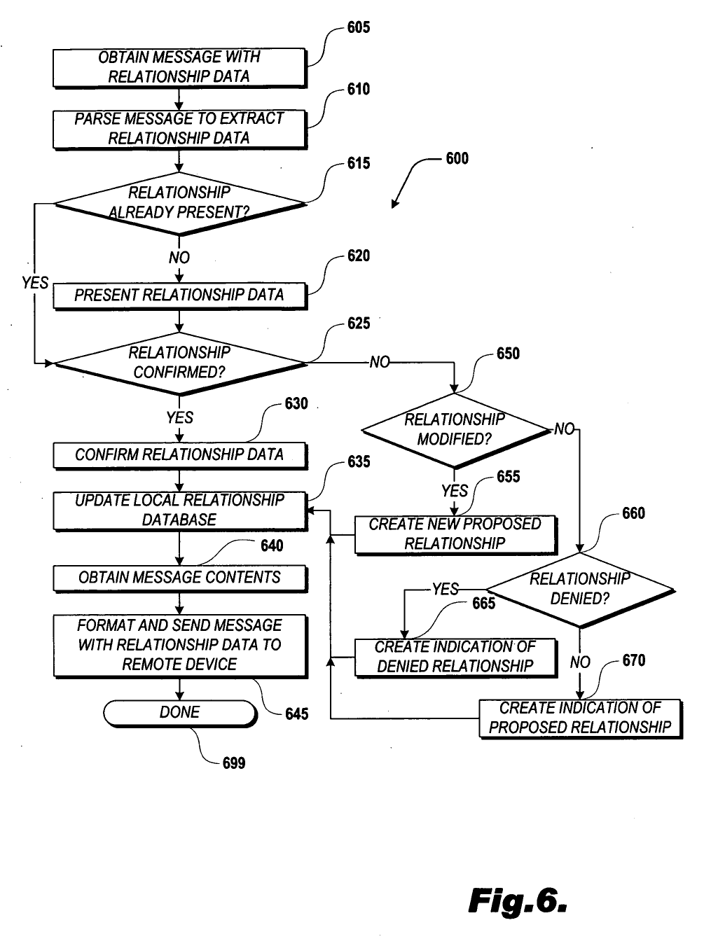

While FIG. 5 illustrates the logic of a routine proposing to define a relationship, FIG. 6 illustrates an exemplary relationship processing routine 600 for processing the proposed relationship. Relationship processing 600 begins at block 605 with a current device obtaining a message having relationship data. In block 610, the message is parsed to extract the relationship data. In decision block 615, a determination is made whether the relationship is already present at the current device (e.g., by looking in a local relationship database such as relationship database 260). If in decision block 615 it was determined that the relationship is not present, processing proceeds to block 620 where the relationship data is presented to a user.

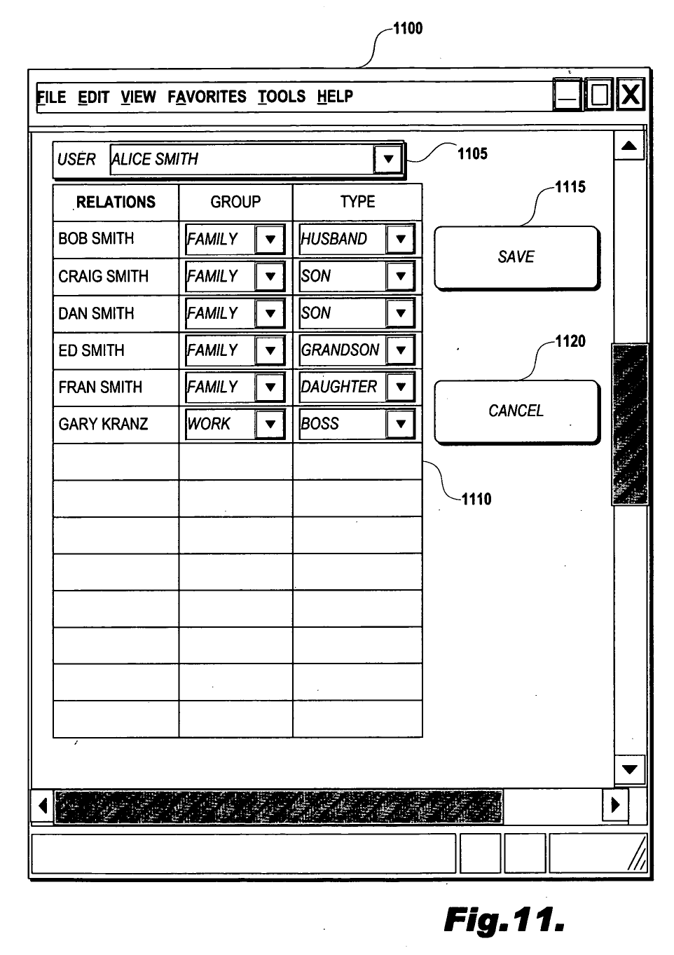

In one exemplary embodiment, the relationship is presented for confirmation based on matching the relationship type to a compatible group of relations already defined by the user. For example, if the user has a group of family relationship contacts, the proposed relationship may be presented as if it were part of a relationship defining user interface (see FIG. 11 for example).

Next, in decision block 625. Likewise, if the relationship was determined to be present in decision block 61 5, processing proceeds to decision block 625 where determination is made whether the relationship was confirmed. If in decision block 625 it is determined that the relationship is confirmed, processing proceeds to block 630 where the local record of the relationship is confirmed and the relationship database (e.g., local relationship database 260 or global relationship database 360) is updated in block 635. Next, in block 640, message contents are obtained. In block 645, a message is formatted with the message contents along with the relationship date and sent to remote device (e.g., an originating user device 200 belonging to a contact whose relationship data was updated). Relationship processing routine 600 ends at block 699.

However, if in decision block 625 it was determined that the relationship was not confirmed, processing proceeds the decision block 650 where determination is made whether the relationship was modified. If in decision block 650 it was determined that the relationship was modified, in block 655 a new proposed relationship is created and processing proceeds to block 635 as described above.

However, if in decision block 650 it was determined the relationship was not modified; processing proceeds to block 660 where determination is made whether the relationship was denied. If the relationship was denied, as determined in decision block 660, processing proceeds to block 665. In block 665, an indication of the denied relationship is created and processing proceeds to block 635.

If, however, in decision block 660, it was determined that the relationship was not denied, processing proceeds to block 670 where an indication of a proposed relationship is created and processing proceeds to block 635.

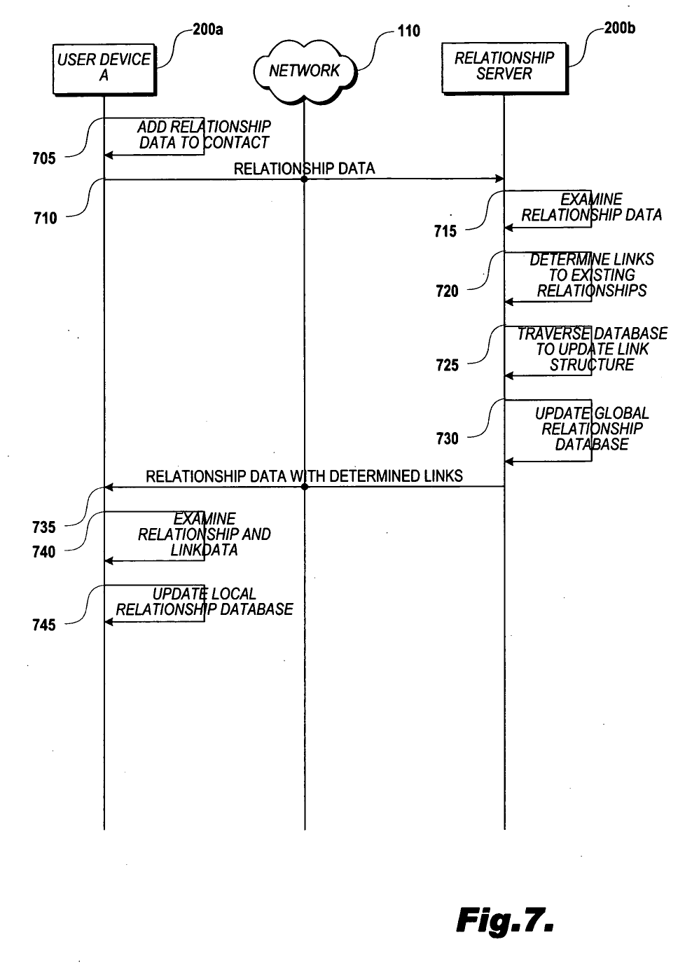

Not all relationship definitions occur in peer-to-peer environments. In some exemplary embodiments, a relationship server 300 may be used to consolidate global relationship information and to analyze relationships between users to determine links. Accordingly, FIG. 7 illustrates an exemplary relationship definition transaction between a first user device 200A and the relationship server 300. In FIG. 7, relationship data is added 705 to a contact at a first user device 200A. The relationship data is sent 710 from first user device 200A to a relationship server 300 via a network 110. The relationship server examines 715, the relationship data and determines any links to existing relationships known to the relationship server (e.g. relationships in a global relationship database 360). The relationship server traverses 725 its database to update the linking that any added relationship data may have caused in the database. The global relationship database is next updated 730 at the relationship server 300. The relationship server 300 may return 735 relationship data with any determined links to update the first user device 200A via the network 110. At first user device 200A, the relationship data is examined 740 along with the link data and the local relationship database (e.g. relationship database 260) is updated 745 with the relationship data and the determined links.

In some embodiments, another device, such as administration device 120, may also be used to manage a global relationship database 360 at the relationship server 300.

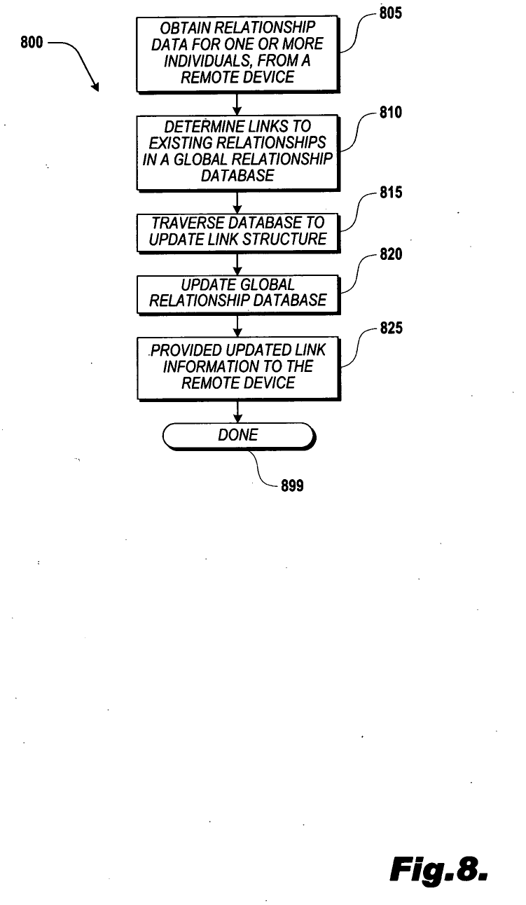

Similar to the operations of the relationship server in FIG. 7, FIG. 8 illustrates a simplified diagram of a relationship and link processing routine for a relationship server 300. Relationship and link processing routine 800 begins at block 805 where relationship data is obtained for one or more individuals from a remote device. Next, in block 810, links to existing relationships in a global relationship database (e.g., global relationship database 360) are determined for the relationship data. In block 815, the global relationship database is traversed to update its link structure and in block 815. Next, in block 820, the global relationship database is updated with the updated link structure. In block 825, the updated link information with corresponding relationship data is provided to the remote device where the relationship was obtained (e.g. a user device 200). Relationship and link processing routine 800 ends at block 899.

In some embodiments, the linking between contacts may be inferred from existing relationships. For example, in a rule-based relationship system where relationships may have associated and reciprocal rules, new relationships may be inferred from existing relationships that have associated rules. Using an analogy of family relationships, if Alice is Bob's brother, and Craig is Bob's son, it can be inferred by that Alice is Craig's Aunt (and Craig is Alice's nephew). An exemplary definition of family relationships using an extensible markup language is shown below:

| | |
|---|---|
| (1) | <?xml version=“1.0” encoding=“utf-8” ?> |
| (2) | - <Family xmlns=“http://www.inkaar.com/Relations” |
| | xmlns:xsi=“http://www.w3.org/2001/XMLSchema-instance” |
| | xsi:schemaLocation=“http://www.inkaar.com/Relations relationtypes.xsd” |
| | Name=“Family” Id=“AAD81FB7-3703-4D6D-AAE0-2EBC018BCBEA”> |
| (3) | <Description /> |
| (4) | - <AllPrivacyControls> |
| (5) | - <Access> |
| (6) | <Type>Public</Type> |
| (7) | </Access> |
| (8) | </AllPrivacyControls> |
| (9) | - <Sibling TypeId=“0f583616-24ef-45a2-882b-ca923ce17804”> |
| (10) | <Description /> |
| (11) | - <AllInverseRelations> |
| (12) | <Relation>Sibling</Relation> |
| (13) | <Relation>Brother</Relation> |
| (14) | <Relation>Sister</Relation> |
| (15) | </AllInverseRelations> |
| (16) | - <AllDefinitionPatterns> |
| (17) | <DefinitionPattern>/Parent/Child</DefinitionPattern> |
| (18) | </AllDefinitionPatterns> |
| (19) | </Sibling> |
| (20) | - <Parent TypeId=“4e67c62f-605e-421b-87da-141f82ca8884”> |
| (21) | <Description /> |
| (22) | - <AllInverseRelations> |
| (23) | <Relation>Child</Relation> |
| (24) | <Relation>Son</Relation> |
| (25) | <Relation>Daughter</Relation> |
| (26) | </AllInverseRelations> |
| (27) | </Parent> |
| (28) | - <Child TypeId=“34a15566-f7db-49c2-acb6-73beebe2e68e”> |
| (29) | <Description /> |
| (30) | - <AllInverseRelations> |
| (31) | <Relation>Parent</Relation> |
| (32) | <Relation>Father</Relation> |
| (33) | <Relation>Mother</Relation> |
| (34) | </AllInverseRelations> |
| (35) | </Child> |
| (36) | - <Friend TypeId=“6cd843ae-a8e0-4c7e-ac6b-12b5fef67596”> |
| (37) | <Description /> |
| (38) | - <AllInverseRelations> |
| (39) | <Relation>Friend</Relation> |
| (40) | </AllInverseRelations> |
| (41) | - <AllDefinitionPatterns> |
| (42) | <DefinitionPattern>/Friend[@DegreeOfSeparation=(0..N)]</DefinitionPattern> |
| (43) | </AllDefinitionPatterns> |
| (44) | </Friend> |
| (45) | - <Brother TypeId=“3d398dcc-2638-4c4c-8aea-a8d75aea7703”> |
| (46) | <Description /> |
| (47) | - <AllInverseRelations> |
| (48) | <Relation>Brother</Relation> |
| (49) | <Relation>Sister</Relation> |
| (50) | <Relation>Sibling</Relation> |
| (51) | </AllInverseRelations> |
| (52) | - <AllDefinitionPatterns> |
| (53) | <DefinitionPattern>Sibling[@Gender=‘Male’]</DefinitionPattern> |
| (54) | </AllDefinitionPatterns> |
| (55) | </Brother> |
| (56) | - <Sister TypeId=“2d8a1624-d795-4e83-aa64-6f6946bfbb52”> |
| (57) | <Description /> |
| (58) | - <AllInverseRelations> |
| (59) | <Relation>Brother</Relation> |
| (60) | <Relation>Sister</Relation> |
| (61) | <Relation>Sibling</Relation> |
| (62) | </AllInverseRelations> |
| (63) | - <AllDefinitionPatterns> |
| (64) | <DefinitionPattern>Sibling[@Gender=‘Female’]</DefinitionPattern> |
| (65) | </AllDefinitionPatterns> |
| (66) | </Sister> |
| (67) | - <Uncle TypeId=“83088c81-36c6-4459-8352-3a622aa5dcf4”> |
| (68) | <Description /> |
| (69) | - <AllInverseRelations> |
| (70) | <Relation>Niece</Relation> |
| (71) | <Relation>Nephew</Relation> |
| (72) | </AllInverseRelations> |
| (73) | - <AllDefinitionPatterns> |
| (74) | <DefinitionPattern>/Parent/Brother</DefinitionPattern> |
| (75) | <DefinitionPattern>/Parent/BrotherInLaw</DefinitionPattern> |
| (76) | </AllDefinitionPatterns> |
| (77) | </Uncle> |
| (78) | - <Niece TypeId=“d5551d09-f754-42dd-8e81-1869632fe7e3”> |
| (79) | <Description /> |
| (80) | - <AllInverseRelations> |
| (81) | <Relation>Uncle</Relation> |
| (82) | <Relation>Aunt</Relation> |
| (83) | </AllInverseRelations> |
| (84) | - <AllDefinitionPatterns> |
| (85) | <DefinitionPattern>Sibling/Daughter</DefinitionPattern> |
| (86) | <DefinitionPattern>BrotherInLaw/Daughter</DefinitionPattern> |
| (87) | <DefinitionPattern>SisterInLaw/Daughter</DefinitionPattern> |
| (88) | </AllDefinitionPatterns> |
| (89) | </Niece> |
| (90) | - <Nephew TypeId=“5fe38317-3001-4eee-a89e-ca6beadec23e”> |
| (91) | <Description /> |
| (92) | - <AllInverseRelations> |
| (93) | <Relation>Uncle</Relation> |
| (94) | <Relation>Aunt</Relation> |
| (95) | </AllInverseRelations> |
| (96) | - <AllDefinitionPatterns> |
| (97) | <DefinitionPattern>Sibling/Son</DefinitionPattern> |
| (98) | <DefinitionPattern>BrotherInLaw/son</DefinitionPattern> |
| (99) | <DefinitionPattern>SisterInLaw/Son</DefinitionPattern> |
| (100) | </AllDefinitionPatterns> |
| (101) | </Nephew> |
| (102) | - <Aunt TypeId=“e2b0403d-c7b8-49c0-a7b0-95d214229877”> |
| (103) | <Description /> |
| (104) | - <AllInverseRelations> |
| (105) | <Relation>Niece</Relation> |
| (106) | <Relation>Nephew</Relation> |
| (107) | </AllInverseRelations> |
| (108) | - <AllDefinitionPatterns> |
| (109) | <DefinitionPattern>/Parent/Sister</DefinitionPattern> |
| (110) | <DefinitionPattern>/Parent/SisterInLaw</DefinitionPattern> |
| (111) | </AllDefinitionPatterns> |
| (112) | </Aunt> |
| (113) | - <Father TypeId=“30f71f47-ffba-4f66-9d2a-9fc19fb3803e”> |
| (114) | <Description /> |
| (115) | - <AllInverseRelations> |
| (116) | <Relation>Son</Relation> |
| (117) | <Relation>Daughter</Relation> |
| (118) | <Relation>Child</Relation> |
| (119) | </AllInverseRelations> |
| (120) | - <AllDefinitionPatterns> |
| (121) | <DefinitionPattern>Parent[@Gender=‘Male’]</DefinitionPattern> |
| (122) | </AllDefinitionPatterns> |
| (123) | </Father> |
| (124) | - <Mother TypeId=“ab6ddbad-9dba-4e53-89c3-371adb48c89e”> |
| (125) | <Description /> |
| (126) | - <AllInverseRelations> |
| (127) | <Relation>Son</Relation> |
| (128) | <Relation>Daughter</Relation> |
| (129) | <Relation>Child</Relation> |
| (130) | </AllInverseRelations> |
| (131) | - <AllDefinitionPatterns> |
| (132) | <DefinitionPattern>Parent[@Gender=‘Female’]</DefinitionPattern> |
| (133) | </AllDefinitionPatterns> |
| (134) | </Mother> |
| (135) | - <Son TypeId=“d9583ed0-5697-4a65-ab5c-b5061d4c45c6”> |
| (136) | <Description /> |
| (137) | - <AllInverseRelations> |
| (138) | <Relation>Father</Relation> |
| (139) | <Relation>Mother</Relation> |
| (140) | <Relation>Parent</Relation> |
| (141) | </AllInverseRelations> |
| (142) | - <AllDefinitionPatterns> |
| (143) | <DefinitionPattern>Child[@Gender=‘Male’]</DefinitionPattern> |
| (144) | <DefinitionPattern>Spouse+/Son</DefinitionPattern> |
| (145) | <DefinitionPattern>Wife/Son</DefinitionPattern> |
| (146) | <DefinitionPattern>Husband/Son</DefinitionPattern> |
| (147) | <DefinitionPattern>Son/Brother+</DefinitionPattern> |
| (148) | </AllDefinitionPatterns> |
| (149) | </Son> |
| (150) | - <Daughter TypeId=“823e75fa-0617-4ff7-b955-0d1a8baba760”> |
| (151) | <Description /> |
| (152) | - <AllInverseRelations> |
| (153) | <Relation>Father</Relation> |
| (154) | <Relation>Mother</Relation> |
| (155) | <Relation>Parent</Relation> |
| (156) | </AllInverseRelations> |
| (157) | - <AllDefinitionPatterns> |
| (158) | <DefinitionPattern>Child[@Gender=‘Female’]</DefinitionPattern> |
| (159) | <DefinitionPattern>Spouse/Daughter</DefinitionPattern> |
| (160) | <DefinitionPattern>Wife/Daughter</DefinitionPattern> |
| (161) | <DefinitionPattern>Husband/Daughter</DefinitionPattern> |
| (162) | </AllDefinitionPatterns> |
| (163) | </Daughter> |
| (164) | - <Cousin TypeId=“822dce51-9a07-4f83-9008-bfe2c7082005”> |
| (165) | <Description /> |
| (166) | - <AllInverseRelations> |
| (167) | <Relation>Cousin</Relation> |
| (168) | </AllInverseRelations> |
| (169) | - <AllDefinitionPatterns> |
| (170) | <DefinitionPattern>Uncle/Child</DefinitionPattern> |
| (171) | <DefinitionPattern>Aunt/Child</DefinitionPattern> |
| (172) | </AllDefinitionPatterns> |
| (173) | </Cousin> |
| (174) | - <Wife TypeId=“96ceb0c6-b7fb-4e1a-bb05-fa18640bc02b”> |
| (175) | <Description /> |
| (176) | - <AllInverseRelations> |
| (177) | <Relation>Spouse</Relation> |
| (178) | <Relation>Husband</Relation> |
| (179) | </AllInverseRelations> |
| (180) | - <AllDefinitionPatterns> |
| (181) | <DefinitionPattern>Spouse[@Gender=‘Female’]</DefinitionPattern> |
| (182) | </AllDefinitionPatterns> |
| (183) | </Wife> |
| (184) | - <Spouse TypeId=“142350a4-98cc-4d22-9d17-606a41048eec”> |
| (185) | <Description /> |
| (186) | - <AllInverseRelations> |
| (187) | <Relation>Spouse</Relation> |
| (188) | </AllInverseRelations> |
| (189) | </Spouse> |
| (190) | - <Husband TypeId=“46314de8-43b2-443b-9bd9-4c3880691584”> |
| (191) | <Description /> |
| (192) | - <AllInverseRelations> |
| (193) | <Relation>Spouse</Relation> |
| (194) | <Relation>Wife</Relation> |
| (195) | </AllInverseRelations> |
| (196) | - <AllDefinitionPatterns> |
| (197) | <DefinitionPattern>Spouse[@Gender=‘Male’]</DefinitionPattern> |
| (198) | </AllDefinitionPatterns> |
| (199) | </Husband> |
| (200) | - <BrotherInLaw TypeId=“67e1306d-8621-40ff-bdc8-68a0c86e7d0a”> |
| (201) | <Description /> |
| (202) | - <AllInverseRelations> |
| (203) | <Relation>BrotherInLaw</Relation> |
| (204) | <Relation>SisterInLaw</Relation> |
| (205) | </AllInverseRelations> |
| (206) | - <AllDefinitionPatterns> |
| (207) | <DefinitionPattern>Wife/Brother</DefinitionPattern> |
| (208) | <DefinitionPattern>Husband/Brother</DefinitionPattern> |
| (209) | <DefinitionPattern>Spouse/Brother</DefinitionPattern> |
| (210) | </AllDefinitionPatterns> |
| (211) | </BrotherInLaw> |
| (212) | - <SisterInLaw TypeId=“6ac1006e-f2e2-4076-91dc-64c72c9b0f6b”> |
| (213) | <Description /> |
| (214) | - <AllInverseRelations> |
| (215) | <Relation>BrotherInLaw</Relation> |
| (216) | <Relation>SisterInLaw</Relation> |
| (217) | </AllInverseRelations> |
| (218) | - <AllDefinitionPatterns> |
| (219) | <DefinitionPattern>Wife/Sister</DefinitionPattern> |
| (220) | <DefinitionPattern>Husband/Sister</DefinitionPattern> |
| (221) | <DefinitionPattern>Spouse/Sister</DefinitionPattern> |
| (222) | <AllDefinitionPatterns> |
| (223) | </SisterInLaw> |
| (224) | - <FamilyMember TypeId=“bff93416-5362-415c-ac5c-c72c7a7bab5d”> |
| (225) | <Description /> |
| (226) | - <AllInverseRelations> |
| (227) | <Relation>FamilyMember</Relation> |
| (228) | </AllInverseRelations> |
| (229) | </FamilyMember> |
| (230) | </Family> |

Of course, other extensible markup schemas may be used to represent other groups of relationships. Different organizations may even form their own types of relationship suited to their organization. By using such rule-based relationships, it possible to gather relationship data from multiple sources and combine relationships (at both the user device 200 and the relationship server 300).

Privacy issues are significant when dealing with personally identifiable information about other people. Accordingly, in various embodiments, users, groups, relation types and contacts can each have privacy settings. In one such embodiment, there are four types of privacy settings: public, private, do-not-forward, and contact-through-me. The generally relate to infinite degrees of sharing, no degrees of sharing, one degree of sharing, and managed sharing, respectively. A public contact's information can be shared and re-shared. A private group cannot be shared and will not be seen by other contacts. A do-not-forward can be shared, but not re-shared with others. While a contact-through-me type would list a contact's name, but would route contact requests to the user who shared the contact.

In still alternate embodiments, additional privacy features may be employed, for example encryption of the local relationship database 260, global relationship database 360 and communications with contacts.

The relationship system 100 presents a mechanism to define one or more relations networks by establishing the common network definitions as described above. An entity using relations client application (e.g., that implements routines 500 and 600) either as a standalone or web-based application, may set one or more relations from a group of relation types to target contacts, thereby creating local relations network. In an illustrative instance of relation creation, the user checks for existing known and inferred relations for any existing relation. The user Actor a relation to target contact, specifying the relation type from one of the group of relation types. The relation system 100 establishes a unique identifiable link locally (e.g., in local relationship database 260 ). The user may then send the relation information to target contact in an e-mail or through some other method.

In addition to sending communications with relationship information, it may be possible import, export and integrate relationship information. Some types of relationship are readily susceptible to modeling. For example, family relationships may be modeled using the GEDCOM genealogical modeling language (GEDCOM is an acronym for GEnealogical Data COMmunication and was developed by The Church of Jesus Christ of Latter-day Saints). Accordingly, it may be beneficial to be able to export specified relationships into a GEDCOM format. Likewise, give a list of contacts and a GEDCOM file, it may be possible to import the list of contacts and GEDCOM file to create a set of contacts that have relationships specified from the GEDCOM file (e.g., through name/age/gender matching and possible user queries for ambiguous matches).

Of course importing and exporting of relations may also be governed by privacy settings. Accordingly, of a user, group, type or contact specifies a “private” setting, they may by default not be exported. However, as the user may have set those privacy settings in the first place, they may also be overridden.

In various embodiments, relationships may be defined synchronously and asynchronously. A relationship is a parseable relation that has a schema associated with it. The parseable relation helps in organizing contacts into logical groups, and to search relations based on conditions in the relation definitions. The relation definitions enable inferring unknown relations from known relations.

Inferring relations may happen periodically in relationship databases, or in real-time when a user queries for contact(s) based on a relationship type. For example, even if a user specified that Alice is Bob's sister, and that Bob is Craig's father, it can be inferred that Alice is Craig's Aunt. Looking at the exemplary family relationship schema listed above, a relationship path from Craig to Alice would look like: “relationship: parent (father)+relationship: sister=relationship: aunt.” By using predefined relationships that have forward and inverse relationship rules, it is possible to combine relationships into paths to infer relations between contacts that do not have specified relationships.

Since the predetermined relation types (as listed in schemas) are bounded, the growth in number of entities would not cause a relation network to be reorganized. This type of network may be useful in defining family networks, work place networks, computer networks and other type of custom networks.

In some embodiments, a contact may have one or more aliases. Aliases may be used to group various contact addresses (e-mail, chat, phone and the like) which belong to the same contact. Relations are generally set between two contacts. Having aliases eliminates setting relations repeatedly when you already have a relation with the same person (but different address). Aliases provide flexibility and simplicity to update and view relations independent of which address has been used to set the relation. Setting an alias would also automatically synchronize the messages and relation history for all the sender's communications (e-mail, chat logs, voicemail, etc.) if there is a relation set with at least one of the aliases of that contact.

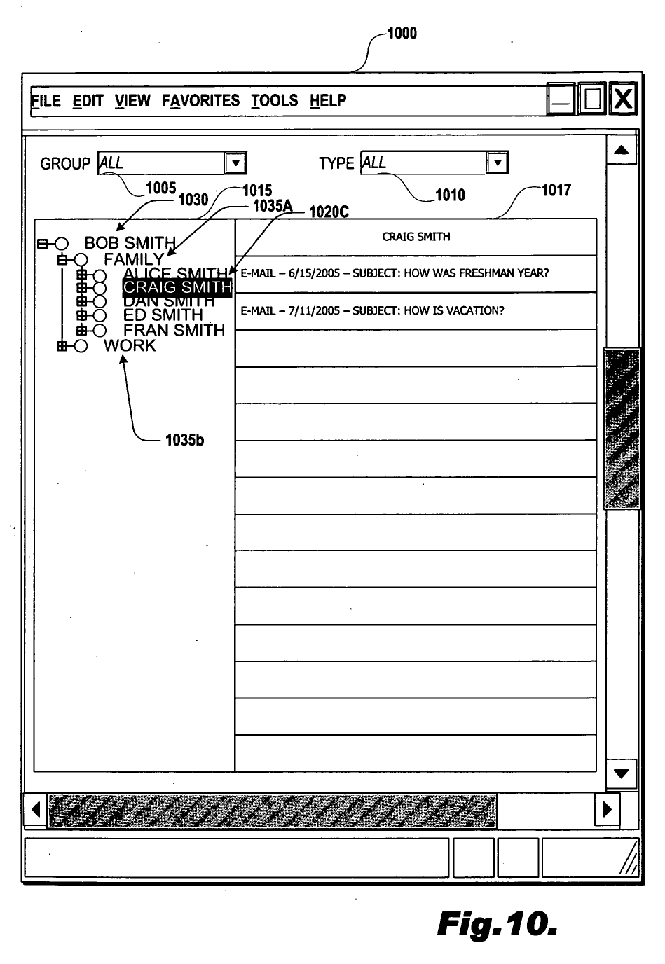

As noted above, communications may be synchronized to capture relation history. Synchronization captures communications with a defined relation (see, for example, FIG. 10). Synchronization, in other words captures the message history and relation history with a contact. This information may also be used to assist in determining the characteristics of a relationship (e.g., strength, happiness, etc.). Synchronizing of messages may be done at a periodically or as prompted by a user. Likewise, all communications may be synchronized, or only a selected subset of communications may be synchronized. Organizing communication histories as relation histories enables users to group information based on predetermined relations, groups or ad hoc groups resulted from search and inference.

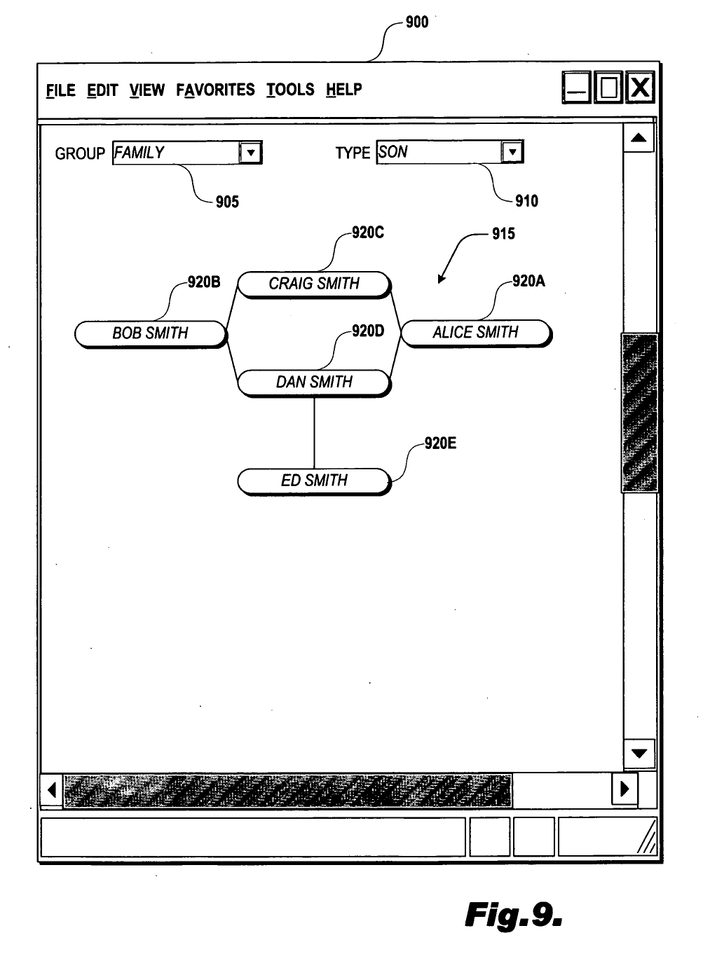

To better illustrate the operations of the transaction and routines described above, FIGS. 9-11 illustrate exemplary user interfaces (“UIs”) suitable for various embodiments.

The relationships indicated in a global relationship database form a “network” of connections that have their own structure. Accordingly, FIG. 9 is a screen shot of an exemplary UI 900 for graphically illustrating the network of relationships between contacts. In UI 900, there are two selection boxes 905, and 910. Group selection box 905 is used to select the relation group of interest and relationship block 910 selects the type of relationship of interest. While these selections are shown as drop-down selection boxes, in other user interfaces they may be show in other forms (e.g., list boxes, text boxes and the like).

In the screenshot illustrated in FIG. 9, the selected relation group is “FAMILY” and the type of relation is “SON”. Accordingly, the illustrated contacts 920A-E all have a “SON” type relationships with the contact to which they are connected. For example, “Dan Smith” 920D is the “SON” of “Alice Smith” 920A. Likewise, “Ed Smith” 920E is the “SON” of “Dan Smith” 920D. Using such a UI, it would then be possible to search for contacts based on their relationships to other contacts.

In further embodiments, it may be possible to search for contacts using additional criteria. For example, search in group “FAMILY” with a location of “Los Angeles” would return an “ad hoc” group of contacts that meet the criteria of being in the FAMILY group and residing in Los Angeles. Likewise other properties of a contact (e.g., name, profession, gender, age, and the like) could be used to search the contacts in addition to the groups and relations types of the contacts.

In some embodiments, such ad hoc groups could be cached or even saved. However, unlike explicit groups, such groups are based one the qualifying criteria. Accordingly, of a contact moved residence out of Los Angles, they would no longer be a part of FAMILY in Los Angeles ad hoc group.

Additionally, some embodiments utilizing relationship-based searches will also provide the relationship path between a user and the searched for contact(s). As there may be multiple paths between the user and the contact(s), some embodiments may search for a relationship path from both the user and the contact; hopefully minimizing the possible permutations that need to be search to find a path between the two. It is worth noting that a relationship path may include one or more relationships that are inferred from known and/or proposed relationships between contacts.

FIG. 10 is a screen shot of an exemplary UI 1000 for locating associated information to a specified contact. In the illustrated UI 1000, user “Bob Smith” 1030 is listed as having two groups, “FAMILY” 1035A and “WORK” 1035B, of relations. The selection boxes 1005, 1010 are both set to include all groups and all types. Contact “Craig Smith” 1020C is highlighted, and in information panel 1017, there is a listing of communications with “Craig Smith” 1020C. The UI is one example of a UI that may be used with an exemplary relationship system to search for information based on relationships. The UI 1000 is suitable for locating information specific to a particular contact, and categorized by their relationship to the user.

While a variety of methods may be used to assign relationships to a contact, including, but not limited to, accepting a proposed relationship, manually configuring relationship data, receiving linked relationship data and the like. FIG. 11 illustrated an exemplary UI 1100 for assigning relationships to contacts. In the exemplary UI 1100, a user is selected in the user selection box 1105. Next, the user's relations with listed contacts are selected based on relationship groups and types in the relationship selection area 1110. The user may then save the relationship(s) (as proposed relationships) by selecting a save button 1115, or may cancel the relationship setting via a cancel button 1120.

Although specific embodiments have been illustrated and described herein, it will be appreciated by those of ordinary skill in the art that a wide variety of alternate and/or equivalent implementations may be substituted for the specific embodiments shown and described without departing from the scope of the present invention. This application is intended to cover any adaptations or variations of the embodiments discussed herein. Therefore, it is manifestly intended that this invention be limited only by the claims and the equivalents thereof.

1-26. (canceled)

27. A computer-implemented method of defining a relationship between entities, the method comprising:
defining a relationship type;
specifying a predefined relationship for a contact from a user;
communicating a message to said contact via a remote device, wherein said message comprises in indication of said relationship;
obtaining a response to said message via said remote device, wherein said response comprises a representation of additional information about said relationship; and
updating a database with said additional information for said relationship.

28. The method of claim 27, further comprising saving a representation of said relationship to said database.

29. The method of claim 27, wherein said predefined relationship information is obtained from a message.

30. The method of claim 27, wherein said message comprises at least one of an e-mail, an instant message, a blog posting, a news posting, a message board posting, a chat session, a video conference, an audio conference, and a multimedia communication.

31. The method of claim 27, wherein said indication comprises at least one of a header, a markup language, an attachment, an embedded code, protocol data, a comment, and structured text.

32. The method of claim 27, wherein said response comprises at least one of an e-mail, an instant message, a blog posting, a news posting, a message board posting, a chat session, a video conference, an audio conference, and a multimedia communication.

33. The method of claim 27, wherein said representation of additional information comprises at least one of a header, a markup language, an attachment, an embedded code, protocol data, a comment, and structured text.

34. The method of claim 27, wherein updating said database comprises confirming said relationship if said additional information meets predetermined criteria.

35. The method of claim 27, wherein said message and said response have an asynchronous relation to each other.

36. The method of claim 27, further comprising parsing said response for said additional information and inferring an inverse relation for said relationship.

37. A computer-readable medium comprising computer-executable instructions for performing the method of claim 27.

38. A computing apparatus comprising a processor and a memory containing computer-executable instructions for performing the method of claim 27.

39. A computer-implemented method of relationship type definition, the method comprising:
specifying a name for a relationship type;
selecting a group of relationship types, wherein said relationship type belongs to said group of relationship types;
specifying any relationship paths for said relationship type;
specifying any inverse relations for said relationship type;
specifying any equivalent relations for said relationship type;
associating an additional attribute with said relationship type; and
updating database with said relationship type.

40. The method of claim 39, further comprising specifying a universal identification for relationship type.

41. The method of claim 39, wherein said relationship path has a root relationship type in said group.

42. The method of claim 39, wherein said additional attribute is selected from the group consisting of: privacy, affinity, role, strength, trust factor, formal protocol, trust establishment protocol, importance, and relationship acceptance token.

43. A computer-implemented method of defining relationship network, the method comprising
obtaining a predefined relationship for a contact from a user, wherein said relationship type is selected from a predetermined group of relationship types;
updating a database with said predefined relationship;
linking said predefined relationship with additional relationships of said predetermined group of relationship types; and
providing a plurality of linked relationships as a relationship network.

44. A computer-implemented method of organizing information based on set relationships, the method comprising:
obtaining a relationship to a user from a database;
synchronizing collaboration information corresponding to said relationship;
organizing said collaboration information corresponding with said relationship into organizing information; and
updating said database with said organization information.

45. The method of claim 44, further comprising rendering said organizing information as a relationship graph.

46. The method of claim 44, wherein said collaboration information comprises at least one of an e-mail, an instant message, a blog posting, a news posting, a message board posting, a chat session, a video conference, an audio conference, a multimedia communication, and targeted communications.

47. The method of claim 44, further comprising exporting said organizing information to external media.

48. The method of claim 44, further comprising uploading said organizing information to a relationship server.

49. The method of claim 44, further comprising importing said organizing information from external media.

50. A computer-implemented method of grouping entities based on relationships, the method comprising:
determining at least one relationship from at least one source entity to at least one target entities;
defining an ad hoc group of entities based one said at least one relationship;
naming said ad hoc group; and
updating a database with said group.

51. The method of claim 50, wherein defining said ad hoc group further is also based on entity attributes.

52. The method of claim 50, wherein defining said ad hoc group further is also based on a relation history of said at least one relationship.

53. The method of claim 52, wherein defining said ad hoc group further is also based on aggregated information from said relation history.

54. A computer-implemented method for searching for a contact, the method comprising:
obtaining a search request including predefined relationship information from a user;
analyzing a database to infer any predefined relationship matching to said predefined relationship information;
querying said database for a contact matching said predefined relationship information; and
providing an indication of at least one matching contact to said user.

55. The method of claim 54, wherein the search request includes at least one of an entity identification, a relation group, a relation network, a predefined relationship, and an entity property.

56. The method of claim 54, wherein the indication comprises at least one matching relation.

57. A computer-implemented method of inferring a relationship to a contact, the method comprising:
obtaining predetermined relationship information from a user;
updating a database with said predetermined relationship information;
analyzing said database to infer any predetermined relationships indicated by said predetermined relationship information; and
providing an indication of at least one inferred relationship to said user.

58. The method of claim 57, wherein said predetermined relationship information is a relationship path.

59. The method of claim 58, wherein analyzing said database comprises traversing said relationship path in at least one direction.
